(19) United States
(12) Patent Application Publication
(10) Pub. No.: US 2006/0198857 A1
(43) Pub. Date: Sep. 7, 2006

(54) Insect control system

(76) Inventor: Enzo Domenico Casagrande, CARDIFF (GB)

Correspondence Address: JACOBS & KIM LLP, 1050 WINTER STREET, SUITE 1000, #1082, WALTHAM, MA, 02451-1401, US

(21) Appl. No.: 10/550,847

(22) PCT Filed: Mar. 24, 2004
(86) PCT No.: PCT/GB04/01289

§ 371 Date: Sep. 23, 2005

(30) Foreign Application Priority Data
Mar. 29, 2003 (GB) 0307322.8

(51) Int. Cl. A01N 25/00

(52) U.S. Cl. 424/405

(57) ABSTRACT

A system for controlling insects, which system includes a substrate in the form of an elongate tape having thereon a plurality of target zones spaced apart at predetermined intervals along a first surface of the substrate, each target zone including an insect attractant and/or an insect control agent.

The present invention relates to a system for controlling insects.

Traditionally insect pests have been controlled by the use of a wide range of pesticides which need to be applied to the crop, thus providing a complete cover so that any insects present are likely to come in contact with it. This approach has the disadvantage of applying the toxicant over the crop leading to the risk of contamination and residues.

Attractants such as pheromones have also been used for control when used in large doses to disrupt the insect's natural mating behaviour, preventing mating and subsequent production of viable offspring. This approach results in little crop contamination but is often expensive and not always a reliable method of pest control.

Attractants and insecticides have previously been combined to form either Attract and Kill or Mass Trapping systems. For Mass Trapping the attractant is used in combination with a physical trapping device which can take the form of either a sticky glue or a no exit trap. Attract and Kill combines the attractant with an insecticide. These can take various forms from sprayable combinations where the insecticide/attractant combination can be spot sprayed on the crop, or in the form of discrete point source type systems. The discrete point source type systems currently available have come in two forms. One form consists of large devices applied in lower numbers (eg 50 to 500 per hectare which are manually attached to the crop. This approach is suitable for certain types of insects such as the Olive fly (Bactrocera oleae) or Medfly (Ceratitis capitata) but can be expensive and laborious to apply. The other form consists of much smaller point sources applied in larger numbers typically over 3000 spaced evenly per hectare. Current examples such as the Bayer Appeal and Syngenta Sirene for the control of Codling moth (Laspeyresia pomonella) in apples are liquid paste formulations which are applied, using a metered pump delivery, as small droplets to the crop. The insect responding to the attractant component touches the droplet and picks up a lethal dose of insecticide. This approach is particularly effective for less mobile insects such as Codling moth but has the substantial limitation of being difficult and slow to apply and the current formulations available have limited field life requiring regular renewal throughout the season.

It is therefore an aim of the present invention to alleviate at least some of the disadvantages identified with prior art insect control system.

It is a further aim of the present invention to provide an improved system for controlling insects.

It is yet a further aim of the preset invention to provide a method of controlling insects, which method is not labour intensive.

Therefore, according to a first aspect of the present invention, there is provided a system for controlling insects, which system includes a substrate in the form of an elongate tape having thereon a plurality of target zones spaced apart at predetermined intervals along a first surface of the substrate, each target zone including an insect attractant and/or an insect control agent.

The substrate is may be wound into a reel or the like. It is also envisaged that the substrate and/or each target zone may be of a biodegradable or bio-erodable material.

Typically, in this embodiment, the interval along the continuous tape between the or each target zone is coated with an adhesive material. The adhesive material may be used to aid the attachment of the product to a crop. Alternatively, the interval along the continuous tape between each target zone may be of an abrasive material or a material which promotes friction between the tape and the crop, thereby aiding attachment of the system to the crop. In addition, this feature would substantially reduce the possibility of the elongate substrate collapsing on itself if it was wound into a reel or the like. However, it is also envisaged that the substrate has a second surface which is alternatively, or additionally, coated with an adhesive material or is manufactured of an abrasive material.

The use of adhesive, or utilising the frictional properties of the tape substantially alleviate the necessity of additional fixing means or support means when the system is in use. It is therefore envisaged that substrate may be the fixing means or support means.

Advantageously, in use, the continuous tape having the target zones thereon, is unwound in the area where the system is to be used. The target zones are advantageously spaced apart at predetermined intervals so as to provide optimum attraction and/or control of the insect. The interval is specific to the insect attractant. The device can therefore be manufactured to provide the correct dosage of insect attractant and/or control agent for a particular crop. The end user of the system can therefore simply position the system (typically by unwinding the substrate) in the desired location without the requirement of measuring the distance between the target zones to ensure that the desired level of protection is achieved. It is particularly advantageous as it is extremely easy to use.

The use of a continuous tape is substantially more convenient to use than prior art methods as it does not require the manual application (typically by spraying) or the positioning of individual traps. The system can be simply unwound in the area (for example the orchard) in which it is to be used, using for example, a motorised vehicle or the like; therefore, substantially less manual labour is required.

The target zone typically includes a laminate structure which includes the insect attractant and the insect control agent. The laminate structure preferably comprises an impermeable layer, the insect attractant layer, a semi-permeable layer and the insect control agent. It is particularly preferred that the impermeable layer is adjacent the substrate. However, it is envisaged that the substrate may be the impermeable layer of the laminate.

The impermeable layer advantageously substantially reduces the insect attractant permeating through to the substrate, thereby preventing unnecessary loss of the insect attracting agent through an area of the system that is not covered by the control agent.

It is particularly advantageous to have a semi-permeable layer between the insect attracting agent and the insect control agent so that the release of insect attracting agent from the system is controlled.

The impermeable layer and/or the semi-permeable layer may be applied by any of the standard processes known, however, it is envisaged that it is typically automated, using for example, a hot melt adhesive slot coater machine. A suitable material for use as an impermeable layer includes a polyester such as a polyester based film.

The attractant may be in the form of a pheromone, a chemical attractant, a food based attractant, a synthetic attractant, a visual attractant, host based attractant or indeed any attractant that would be able to attract the insect to be controlled to the system.

Examples of such attractants include chemical attractants (including pheromone and kairomone attractants) which may be selected from the following list, which is given by way of example only:

Z-5-decenyl acetate, dodecanyl acetate, Z-7-dodecenyl acetate, E-7-dodecenyl acetate, Z-8-dodecenyl acetate, E-8-dodecenyl acetate, Z-9-dodecenyl acetate, E-9-dodecenylacetate, E-10-dodecenyl acetate, 11-dodecenyl acetate, Z-9,11-dodecadienyl acetate, E-9,11-dodecadienyl acetate, Z-11-tridecenyl acetate, E-1-tridecenyl acetate, tetradecenyl acetate, E-7-tetradecenyl acetate, Z-8-tetradecenyl acetate, E-8-tetradecenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tridecadienyl acetate, 4-methoxy-cinnamaldehyde, .beta.-ionone, estragole, eugenol, indole, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7,11-hexadecadienyl acetate, Z,E-3,13-octadecadienyl acetate, E,Z-3,13-octadecadienyl acetate, E,E-3,13-octadecadienyl acetate, ethanol, hexanol, heptanol, octanol, decanol, Z-6-nonenol, E-6-nonenol, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,10-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9,11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, E-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9,11-hexadecadienal, E,E-10,12-hexadecadienal, E,Z-10,12-hexadecadienal, Z,E-10,12-hexadecadienal, Z,Z-10,12-hexadecadienal, Z, Z-11,13-hexadecadienal, octadecanal, Z-11-octadecenal, E-13-octadecenal, Z-13-octadecenal, Z-5-decenyl-3-methyl-butanoate Disparlure: (+) cis-7,8-epoxy-2-methyloctadecane, Seudenol: 3-methyl-2-cyclohexen-1-ol, sulcatol: -methyl-5-hepten-2-ol, Ipsenol: 2-methyl-6-methylene-7-octen-4-ol, Ipsdienol: 2-methyl-6-methylene-2,7-octadien-4-ol, Grandlure I: cis-2-isopropenyl-1-methyl-cyclobutanethanol, Grandlure II: Z-3,3-dimethyl-1-cyclohexanethanol, Grandlure III: Z-3,3-dimethyl-1-cyclohexaneacetaldehyde, Grandlure IV: E-3,3-dimethyl-1-cyclohexaneacetaldehyde, cis-2-verbenol: cis-4,6,6-trimethylbicyclo>3,1,1!hept-3-en-2-ol cucurbitacin, 2-methyl-3-buten-2-ol, 4-methyl-3-heptanol, cucurbitacin, 2-methyl-3-buten-2-ol, 4-methyl-3-heptanol, .alpha.-pinene: 2,6,6-trimethylbicyclo>3,1,1!hept-2-ene, .alpha.-caryophyllene: 4,11,11-trimethyl-8-methylenebicyclo>7,2,0!undecane, Z-9-tricosene, .alpha.-multistriatin 2(2-endo, 4-endo)-5-ethyl-2,4-dimethyl-6,8-dioxabicyclo>3,2,1!octane, methyleugenol: 1,2-dimethoxy-4-(2-propenyl)phenol, Lineatin: 3,3,7-trimethyl-2,9-dioxatricyclo>3,3,1,0!nonane, Chalcogran: 2-ethyl-1,6-dioxaspiro>4,4!nonane, Frontalin: 1,5-Dimethyl-6,8-dioxabicyclo>3,2,1!octane, endo-Brevicomin: endo-7-ethyl-5-methyl-6,8-dioxabicyclo>3,2,1!octan, exo-brevicomin: exo-7-ethyl-5-methyl-6,8-dioxabicyclo>3,2,1!octane, (Z)-5-(1-decenyl)dihydro-2-(3H)-furanone, Farnesol 3,7-11-trimethyl-2,6,10-dodecatrien-1-ol, Nerolidol 3,7-,11-trimethyl-1,6,10-dodecatrien-3-ol, 3-methyl, 6-(1-methyl ethenyl)-9-decen-1-ol acetate, (Z)-3-methyl-6-(1-methylethenyl)-3,9-decadien-1-ol acetate, (E)-3,9-methyl-6-(1-methylethenyl)-5,8-decadien-1-ol-acetate, 3-methylene-7-methyl-octen-1-ol propionate, (Z)-3,7-dimethyl-2,7-octadien-1-ol propionate, (Z)-3,9-dimethyl-6-(1-methylethenyl)-3,9-decadien-1-ol propionate.

It is particularly preferred that the attractant is in the form of a reservoir layer on the substrate (this is particularly desirable when the attractant is a pheromone).

The attractant is typically mixed with a carrier material so as to form the reservoir layer. The carrier material acts as a carrier for the pheromone on the laminate system.

Typically, the reservoir must be a solid material at normal operating temperatures. The reservoir is preferably tacky so that it assists in bonding to the impermeable layer and the semi-permeable layer.

The carrier material may be a hot melt or pressure sensitive adhesive polymer, or a mixture of two or more such polymers. Polymers that may be used as the carrier include Ethylene vinyl acetates (which is preferred), Hot melt adhesive mixes, Poly vinyl acetate (PVA) Poly vinyl chlorides (PVCs) and crossed linked acrylates. However, it is envisaged that any material having the desired properties may be used.

A particularly preferred carrier material is a glue based mixture. At the desired level of hardness and tack the reservoir layer is permitted to bond to the impermeable layer and the permeable layer. However, it is envisaged that any polymer based material having the desired properties (including tack) could be used according to the present invention.

The insect attractant (such as a pheromone) is typically dispersed in the polymer mixture so as to form the attractant reservoir. In order to manufacture the reservoir, the polymer carrier is heated until it melts and is thoroughly stirred so as to achieve homogeneity. The required amount of attractant is subsequently added to the melted polymer carrier. Typically, a colour dye marker is used to visually confirm the distribution of the insect attractant. A preferred amount of attractant is 0.5 to 50% by weight of the reservoir, preferably 1 to 25% by weight of the reservoir, further preferably 1 to 10% by weight of the reservoir.

The impermeable layer may include vapour proof substrates that are commercially available in the packaging industry. A preferred material is a polymer-based film.

The semi-permeable layer has the function of permitting controlled release of the insect control agent from the system. The choice of the material type (such as a polymer and thickness) will determine how much the release of the attractant (which is typically dissolved in the reservoir) is moderated.

The insect control agent may be an insecticide. However, it is also envisaged that the insect attractant may also act as a control agent. For example, the insect attractant may be used to deliver higher quantities of attractant so that it can alternatively be used to disrupt or disorientate the insect.

It is also envisaged that the control agent may be an insect repellent arranged to deter an insect from the vicinity of the system. In this embodiment, would be no requirement to have an insect attractant.

It is also envisaged that the substrate can be the control agent so as to provide a mass trapping type system; in this embodiment an adhesive is attached to a surface of the substrate, the adhesive being arranged to trap the insect should it land on the substrate.

According to a further aspect of the present invention, there is provided a method of controlling insects in a defined area, for example, an orchard or the like, which method includes providing a system for controlling insects substantially as described hereinbefore, and positioning the system throughout the defined area.

According to this aspect of the present invention the system is preferably in the form of a reel or continuous tape that can be unwound when the system is being positioned in the defined area. The reel or continuous tape is substantially as described hereinbefore.

The system according to the present invention is particularly advantageous in the attracting and therefore controlling of the codling moth (Laspeyresia pomonella). In this embodiment, the insect control agent could be the Lambda Cyhalothin which is available under licence from Syngenta.

### Experimental Data

Selection of semi-permeable layer

The semi-permeable layer is the main controlled release mechanism in this system. The choice of the polymer type and thickness will determine the release rate of the attractant component of the control device. In order to obtain the characteristics from different substrates, a number of readily available polymer films were assessed. Four different polymers were tested—36 μm polyester (PE), 50 μm polypropylene (PP), 100 μm high density polyethylene (HDPE) and a 100 μm laminate consisting of 20 μm polypropylene and 80 μm low density polyethylene (2 L). The 2 L laminate was produced with small perforations (˜30/cm²) in the PP layer only.

For the purpose of the experiments the pheromone mix was coated onto the PE backing layer and different semi-permeable layers were then welded to the mix to form the pheromone laminate.

Laboratory Assay Methods

30 lures of each type were exposed in the test area where temperatures were cycled daily between ˜15 and 30° C. The lures were kept ventilated to prevent localised build up of pheromone. Samples were collected on a weekly basis for the length of the experiment, extracted and analysed by standard Gas Chromatography procedures.

### EXPERIMENT 1

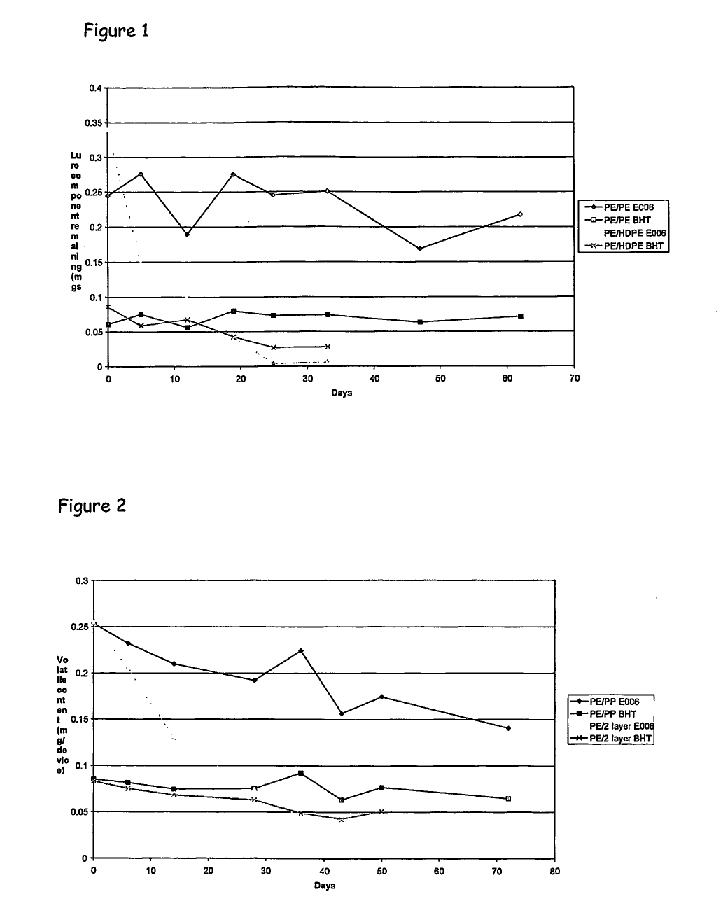

The first experiment assessed the performance of some basic formulations. A ˜5% loaded pheromone reservoir blend was produced (BHT was added as a standard stabiliser). This was coated at ˜50 gsm onto the impermeable PE backing material and either another layer of PE or the HDPE film added as the semi-permeable layer. These were set up for a standard release rate study. The results of this experiment are presented in FIG. 1.

As can be seen from FIG. 1 the pheromone (E006) released very slowly from the double PE sandwich formulation. There appears to be a slow tendency for some pheromone loss but this is difficult to assess because of the large variability between samples. Given that the PE is essentially impermeable any loss of pheromone is likely to have been from the edges of the sandwich. For the BHT which is also volatile release was essentially zero for the same formulation.

The release rate of the PE/HDPE formulation was markedly different. All the pheromone released within 25 days of commencement. The BHT released more slowly with approximately 50% lost over the same interval.

From this experiment it is clear that the PE/PE option is too slow releasing while the PE/HDPE version is too fast. An intermediate option is required.

### EXPERIMENT 2

The above experiment was repeated but this time new semi-permeable polymer films were tested. Laminates based on PE/PP and PE/2L were produced and release rate evaluated. The results are presented in FIG. 2.

In this trial the PE/2L option released its pheromone over a 50 day period at essentially half the rate of the PE/HDPE variant tested in Experiment 1. The release of the BHT was also substantially slowed in the PE/2L formulation. This formulation would be suitable if a faster releasing option is required.

The PE/PP formulation was substantially slower releasing. In this trial approximately 50% of the pheromone was lost over a period of 75 days. Based on this the formulation could potentially last over 150 days. This would be ideal for a season long control product. Based on these results the PE/PP formulation was chosen as the basis for further development.

### EXPERIMENT 3

Effect of changing the percentage of pheromone in the reservoir blend

The next series of experiments evaluates the effect of changing the percentage of pheromone in the reservoir blend on the release rate of different laminate systems. The different laminate systems were produced with higher and lower pheromone loading. The initial aim was to test a 2.5% and a 10% formulation.

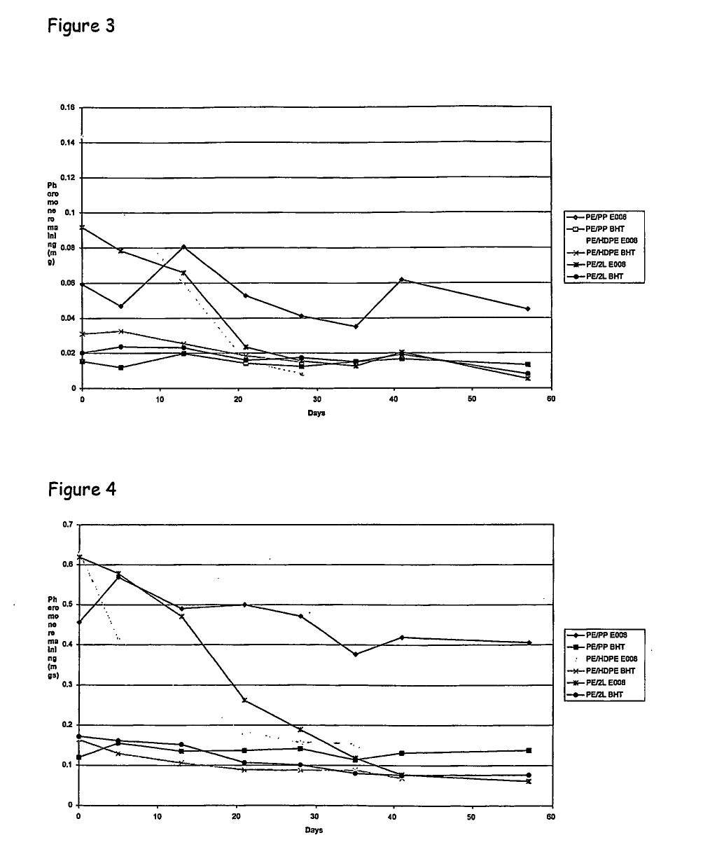

The results of this experiment are presented in FIG. 3 and FIG. 4. The overall impression is that changing the pheromone loading does not dramatically change the longevity of each formulation type. Based on this data the 1.6% formulations lost the same proportion of pheromone over time as the 10% version and both of these were very similar but slower than those observed for the 5% formulations in the previous experiments. There is a considerable error in the behaviour of the 1.6% version and therefore it is difficult to assess how accurate the prediction of longevity is. Also it is typical of controlled release formulations for the release rate to slow as the pheromone runs out causing a long tail in the release rate curve. Since the formulation was only loaded with a small amount of pheromone this tail effect could have been significantly larger in this formulation resulting in an extended longevity but with low daily release rate.

### ANALYSIS OF DATA

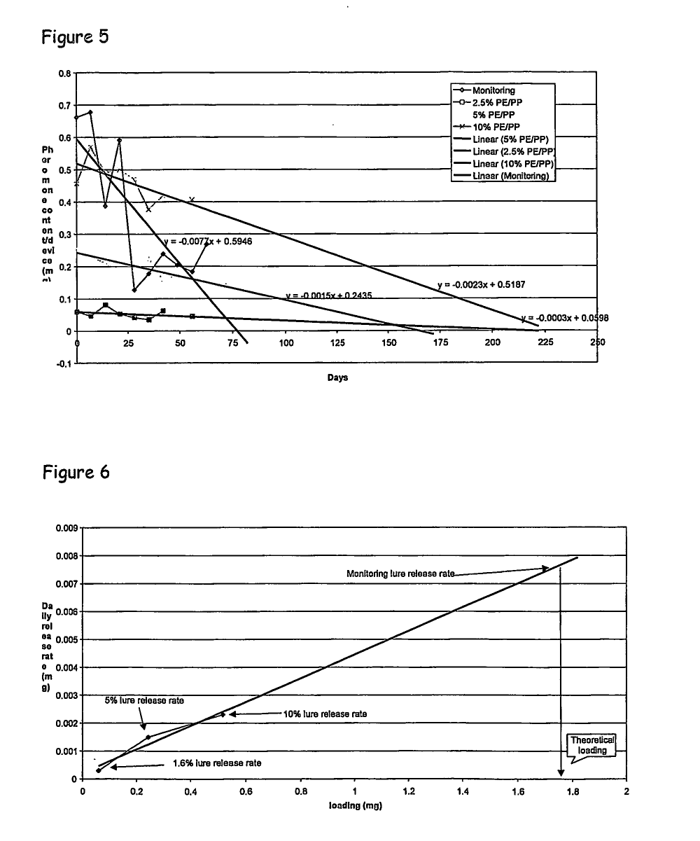

Best fit lines were fitted to the PP/PE release rate curves of the three of the pheromone loadings tested. This is shown in FIG. 5. From these slopes daily pheromone release rate and formulation longevity was predicted. This information is presented in Table 1. The release rate curves of standard monitoring lures were also fitted the laminate formulations must reasonably match the daily release rate of the monitoring lures if they are to achieve the required efficiency in attracting moths. The monitoring lures have previously been optimised to maximise insect attraction into traps.

An alternative method of predicting the required initial pheromone loading is shown in FIG. 6, where the pheromone loading is plotted against daily release and a best fit line fitted.

TABLE 1
Analysis of release rate data

| | | | Expected | Release/ |
|---|---|---|---|---|
| Formulation | Loading | Release slope | life | day |
| 10% | 0.5 mg | y = −0.0023x + 0.5187 | 225 days | 0.0023 |
| formulation | | | | mg/day |
| 5% | 0.25 mg | y = −0.0015x + 0.2435 | 160 days | 0.0015 |
| formulation | | | | mg/day |
| 1.6% | 0.08 mg | y = −0.0003x + 0.0598 | 220 days | 0.0003 |
| formulation | | | | mg/day |
| Monitoring | 1 mg | y = −0.0077x + 0.5946 | 77 days | 0.0077 |
| lure | | | | mg/day |

Given that the daily release rate of the laminates must be the same as the monitoring lure, based on Table 1. the 10% loaded formulation must be correspondingly larger to contain 1.7 mg of pheromone. The 5% version is slightly slower releasing so the laminate must be larger still and contain 2.6 mg of pheromone. Given its very low release rate the 1.6% option must be so large as to be impractical. Therefore, from FIG. 6, it is predicted that the initial loading should be circa 1.8 mg/2 square centimetres.

It was decided that 10% pheromone would be a convenient loading for further work. Based on the above calculations a target point source loading was chosen for further development work. To achieve this using a 10% mix on a 2 square cm device would require a coating of about 100 gsm between the laminating films. Samples were therefore produced at 100 gsm as well as 50 gsm and 150 gsm and a further release rate study commenced.

### EXPERIMENTS 4 AND 5

Insect Response to System

For the system according to the present invention to work efficiently it is critical that the insect respond to the pheromone lure in the control agent and actually approach and touch it long enough to pick up a lethal dose of insecticide. This experiment was run to assess the insect response to the prototype system.

### MATERIALS AND METHODS

There are two main requirements of the system. It must effectively kill the insect and the chosen formulation must remain active for the field life of the product. The micro-encapsulated formulation of lambda cyhalothrin from Syngenta has already been shown to give at least 6 months residual life on another Attract and Kill product commercialised for the control of Olive fly and is therefore the insecticide of first choice for this product.

The Olive fly device currently on the market contains ˜15-20 mg active ingredient per card. At 800 cm² per card and at 100 devices per hectare this is a total of 3000 mg insecticide per hectare or about 0.025 mg per cm² of card. The system of the present invention is typically ˜2-3 square centimetres per individual point source. Based on the experience of other products on the market for the control of codling moth (Bayer Appeal & Syngenta Sirene) approximately 4000 point sources will be required per hectare.

### EXPERIMENT 4

Treatments

Insecticide Preparations

The following experimental insecticide formulations were prepared for mortality trials.
Type 1.1 2002 Std Olive fly target using 11% PVA coated on plastic laminate at 0.05 mg/2 square cm
Type 1.2 2003 version Olive fly target using 1% PVA coated on plastic laminate at 0.05 mg/2 square cm
Type 1.3 Technical grade Lambda cyhalothrin mixed at 2% in vegetable oil* on paper laminate at 0.05 mg/2 square cm
Type 1.4 Technical grade Lambda cyhalothrin mixed at 2% in vegetable oil* on paper laminate at 1 mg/2 square cm (high dose)
   * the oil provided a suitable substrate and diluant for the insecticide.

### EXPERIMENT 5

Treatments

Based on the results of the first trial a further range of insecticide formulations were prepared. These were compared against the best options from the first experiment. The aim was to see if a longer life versions of the technical based formulation could be developed and if a higher dose can be achieved based on the Demand CS.

The following formulations were developed:
Type 2.1 Technical grade Lambda cyhalothrin mixed at 2% in vegetable oil on paper laminate at 1 mg/2 square cm
Type 2.2 Technical grade Lambda cyhalothrin mixed at 2% in vegetable oil & 1% Waxolene black on paper laminate at 1 mg/2 square cm
Type 2.3 Technical grade Lambda cyhalothrin mixed at 2% in vegetable oil & 1% Waxolene black+5% TiO2 on paper laminate at 1 mg/2 square
Type 2.4 Demand based formulation with 54.5% microencapsulated lambda cyhalothrin, 0.5% PVA & 45% water on paper laminate at 0.2 mg/2 square cm
Type 2.5 Demand based formulation with 99% microencapsulated lambda cyhalothrin, 1% PVA on paper laminate at 0.4 mg/2 square cm
   Insect Mortality trials

Insects were anaesthetised with CO₂ and placed on the surface feet down as though they had landed for 5 seconds. Each experiment was run in two batches repeated using new insecticide squares for the treatments.

### RESULTS AND DISCUSSION

Insect Mortality Trials

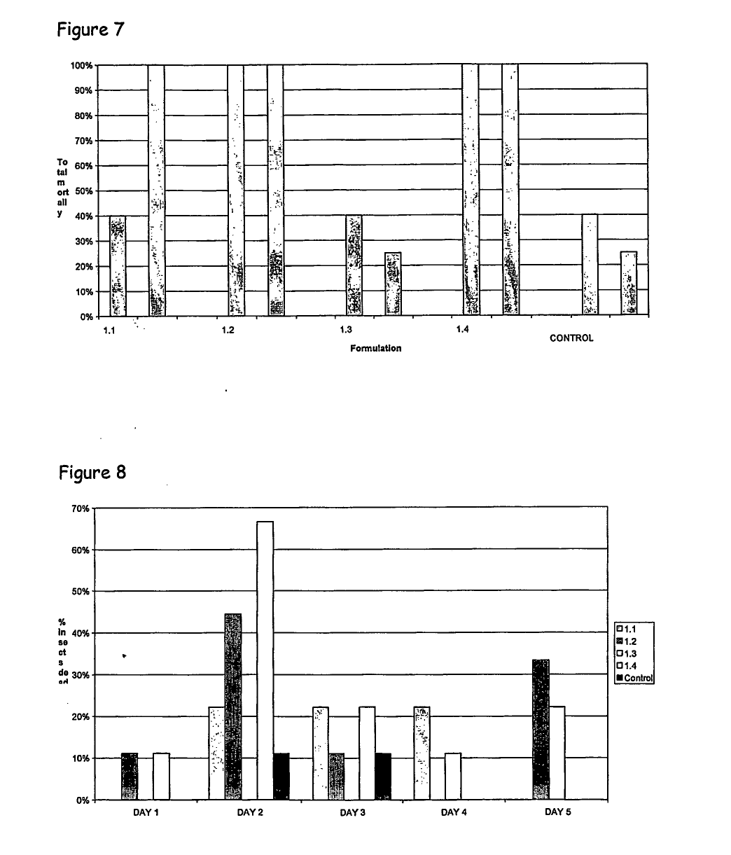

The results of the first mortality experiment are presented in FIG. 7 and FIG. 8. FIG. 7 shows the total mortality for the different treatments. It is clear from this that both treatments 1.2 with a lower PVA content and 1.4 with a high dose of insecticide achieved 100% mortality in this trial. Treatment 1.1 was effective in the second run but no different to the control in the first. Treatment 1.3 which was the neat insecticide at the same rate as 1.1 and 1.2 performed no better than the control.

FIG. 8 shows that the rate differed between the formulation types. Types 1.2 and 1.4 were the only ones to achieve any kill on the first day. For these two most of the kill occurred on the second. It should be noted that for 1.2 the mortality was spread over a longer period with moths still dying on the fifth day. The 1.1 treatment also had slow mortality with deaths spread evenly over the second to fourth days. The ineffectiveness of the 1.3 treatment is confirmed with the few deaths occurring on the last two days—after those in the control.

From this experiment it can be concluded that the microencapsulated lambda cyhalothrin formulation improves the efficacy of the insecticide with both treatments 1.1 and 1.2 outperforming the same rate of active in 1.3. This can be compensated for by increasing the amount of active 20 fold in treatment 1.4. There is some evidence that the level of PVA (used to bond the insecticide formulation to the substrate) also affects the mortality with treatment 1.2, containing less PVA, out performing treatment 1.1.

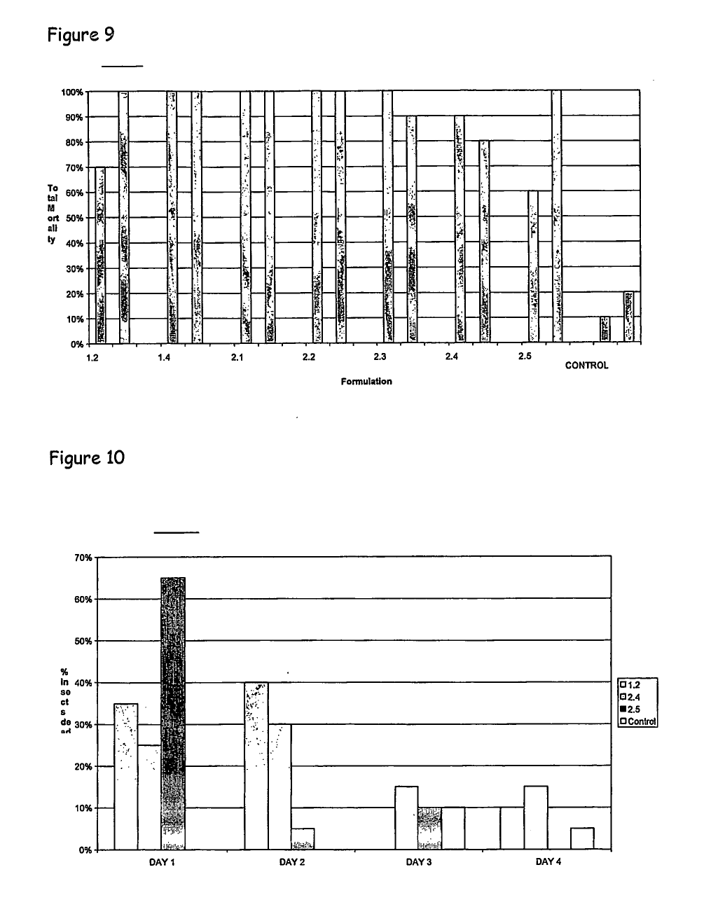

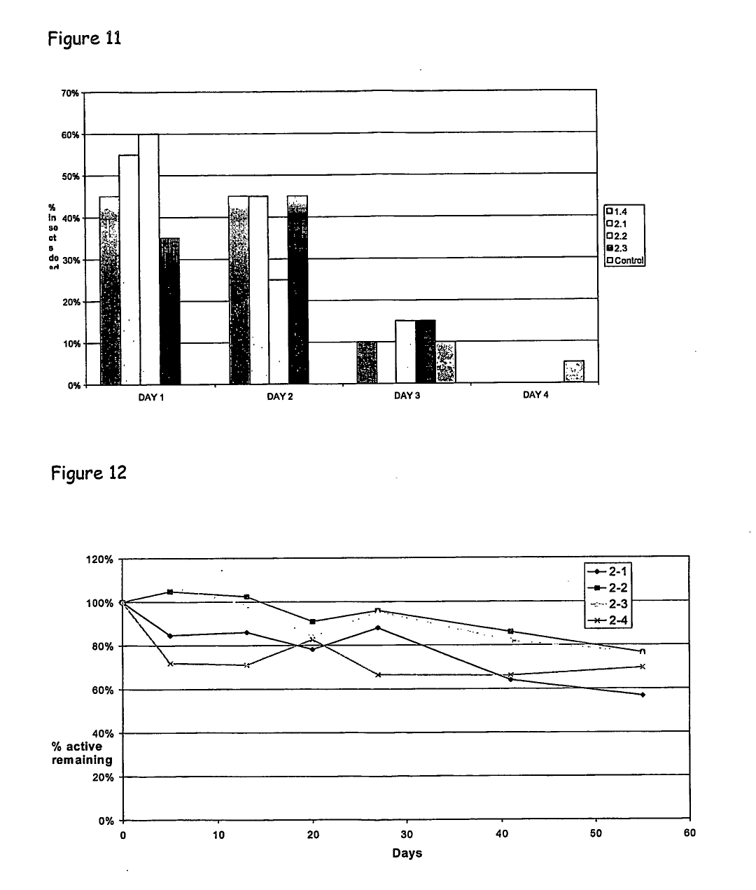

Experiment 5 was carried with the best options from Experiment 4 adding new variants likely to be useful on the final formulation. Two avenues were explored. The first was to optimise the tried and tested microencapsulated lambda cyhalothrin formulation. The second was to see if what could be done with the neat technical insecticide. The results for the total mortalities are presented in FIG. 9 and, for the rates of kill, by formulation avenues in FIG. 10 and FIG. 11.

Microencapsulated lambda cyhalothrin formulations: Treatment 1.2 was a repeat of one of the better treatments of experiment 4, again good mortality was achieved in the second run but less so in the first. Treatments 2.4 and 2.5 were modified versions of this treatment. Overall total mortality was very similar between all three. This is despite increasing the insecticide dose from 0.05 mg/2 square cm in treatment 1.2 to 0.2 mg in treatment 2.4 and 0.4 mg in treatment 2.5. The other significant change is the switch from the plastic laminate in 1.2 to paper laminates in 2.4 and 2.5 and there was a change in PVA content between 2.4 and 2.5.

There are some differences in the rate of kill between treatment with 2.5 killing more quickly than 1.2 which in turn is quicker than 2.4. For some reason mortality appears to be quicker in this experiment than it was in Experiment 4. This may be related to the conditions of the trial or fitness of the test insects.

It is unclear why mortality did not increase with the increased insecticide loading. The change from the smooth surfaced plastic laminate to the paper substrate may be an important factor. The paper surface may render the insecticide capsules less accessible particularly as the insects were anaesthetised so would not have been grasping at the surface with their tarsi. The PVA may also be an important factor. This was added to the Olive fly formulations to adhere the insecticide capsules to the otherwise smooth and non adherent plastic laminate surface. The capsules are likely to adhere without any bonding agent to the paper surface and the presence of the PVA may inhibit their easy removal by the insect.

In the current series of experiments it was not practical to apply a higher dose of active to the Demand based formulations because of the limitations of trying to dose on the required amount of the 10% active Demand formulation.

For the technical active based formulation (FIG. 11) there is little difference in either mortality or rate of kill. Most of the insect died within 2 days of treatment with the remainder dying on the third day. This is probably not surprising given the much higher insecticide rate used.

The addition of stabilisers appears to make little difference to the performance of the formulation.

From experiments 4 and 5 it would seem clear that the technical active based formulations would be more effective options for this product. The facility of applying higher rates of insecticide would appear an attractive option. Of course these are only short laboratory based studies and there is no information about how the technical formulations would perform in the field over extended periods. While this may be an avenue well worth continuing to explore we can not abandon the microencapsulated lambda cyhalothrin based formulations. For these we have definite evidence of their long term stability and efficacy based on our experiences with the Olive fly product.

### EXPERIMENT 6

Insecticide Ageing Trials

The system according to the present invention is intended to last for an entire season. In the case of Codling moth this can be up to 5 months under Mediterranean summer conditions. An initial test was carried out to evaluate some of the more promising insecticide formulations to determine their potential field longevity.

### MATERIALS AND METHODS

Samples of the different insecticide formulations coated onto the likely final substrate were attached to trees outside the AgriSense factory and exposed to the natural elements. The trial commenced in early February. Samples were collected at regular intervals and analysed by Gas Chromatography for total insecticide content and degradation compounds.

The four formulations that were evaluated are identified in Experiment 5 as Type 2.1, Type 2.2, Type 2.3 and Type 2.4

### RESULSTS AND DISCUSSION

The trial was carried out during a relatively cold and wet part of the year so the levels of UV and the amount of rain the samples would have experience may not reflect the circumstance under which they would normally be used. The results of the trial are shown in FIG. 12. For all the treatments there is a slow loss of active over the period of the trial. Predictably the 2.1 formulation with no UV blockers has lost the most active. Formulation 2.4 based on the microencapsulated Demand formulation appeared to loose quickly at the start but this then slowed and there was very little loss thereafter. This may reflect a washing off of loose micro caps at the start and could indicate that a better binder is needed for this formulation. There is little difference between formulation 2.2 and 2.3.

The experiment shows at least that all the formulations tested show good rain fastness. Given the low temperatures and low light this experiment may not give too much information on the UV and thermal stability of these formulations. This will have to be tested later in the year under normal field use conditions.

### EXPERIMENT 7

Determination of Insect Response to System

If the system is to work efficiently it is critical that the insect respond to the pheromone lure and actually approach and touch it long enough to pick up a lethal dose of insecticide. This experiment was run to assess the insect response to the prototype pheromone dispensing system according to the present invention.

### MATERIALS AND METHODS

Newly emerged moths were sexed and only males used in the attractant trials. Moths were kept with food and water at ˜20° C. prior to use in the trial.

Initial experiments were started within one or two days of the insect emergence and over the subsequent 2 days. The trial was carried out a wind tunnel measuring 150×30×30 cm. The test lure was attached to a wire at the upwind end of the tunnel and individual insects released at the down wind entrance. Each replicate was run over 3 minutes. The insect behaviour was observed. If the insect failed to reach the pheromone source within the 3 minutes it was counted as a non response. Contact pheromone lure and total source contact time were recorded.

### RESULTS AND DISCUSSION

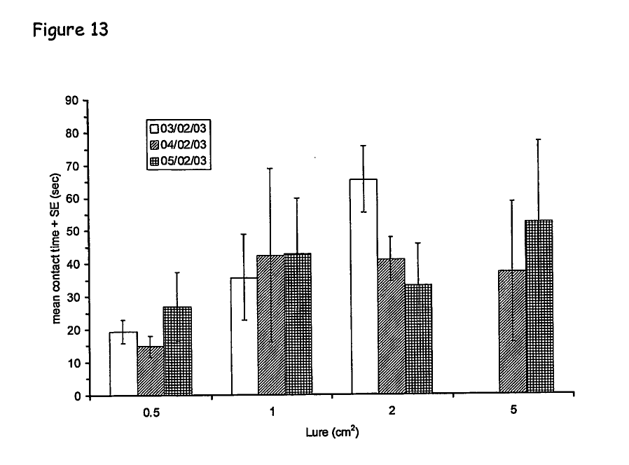

The results of this experiment are shown in Table 2 and in FIG. 13. The percentage reaching the source was 60% at its lowest for the 2 sq. cm on the first day but was above 80% for all treatments on subsequent days.

TABLE 2
Response of codling moth to different sized
Ecotape pheromone dispensing devices.

| | 0.5 sq. | 1 sq. | 2 sq. | 5 sq. |
|---|---|---|---|---|
| Lure area | cm | cm | cm | cm |
| Mar. 02, 2003 | | | | |
| Residence time | 19.4 | 35.75 | 65.3 | |
| (secs) | | | | |
| +/−SE | 3.6 | 13.0 | 10.2 | |
| % reaching | 100% | 80% | 60% | |
| source | | | | |
| Apr. 02, 2003 | | | | |
| Residence time | 14.8 | 42.4 | 41 | 37.2 |
| (secs) | | | | |
| +/−SE | 3.2 | 26.3 | 6.6 | 21.5 |
| % reaching | 100% | 100% | 80% | 100% |
| source | | | | |
| May 02, 2003 | | | | |
| Residence time | 27 | 42.75 | 33.2 | 52.4 |
| (secs) | | | | |
| +/−SE | 10.5 | 16.9 | 12.4 | 24.7 |
| % reaching | 100% | 80% | 100% | 100% |
| source | | | | |

The residence time seems to increase with lure size from 0.5 to 1 sq. cm and remains relatively constant there after. There is no evidence of a repellent or disruptant effect at the higher doses tested. The residence time was over 30 seconds for all except the 0.5 sq. cm lures and even with these the insects stayed for an average of approximately ˜20 seconds. It is well known that this species is inhibited from entering traps at higher pheromone release rates. Based on current results the release rate of even the largest size tested has not reached the upper insect response threshold.

FIG. 13 graphically shows the residence time of codling moth in response to different sized pheromone dispensing systems.

### CONCLUSIONS

Over the range of pheromone lures size and, consequently, release rate, the insects responded very well to the pheromone lure and spent a relatively long time in contact with the source. The time spent even at the lowest pheromone lure size should provide ample opportunity for the insects to pick up a lethal dose of insecticide in the final product presentation. This gives up great scope to vary the device size and loading to match attractive pheromone release at the beginning of the season with pheromone release at the end when the lure has deteriorated and is releasing less pheromone.

### EXPERIMENT 8

Determination of Insect Response to the System According to the Present Invention

If the system is to work efficiently it is critical that the insect respond to the pheromone lure and actually approach and touch it long enough to pick up a lethal dose of insecticide. The previous experiments assess the performance of the separate components of the system. This final experiment assesses the efficacy of a complete prototype pheromone/insecticide system.

### MATERIALS AND METHODS

Insects were supplied from a laboratory reared culture by Horticultural Research International in Wellesbourne (HRI). These were received as pupae and allowed to emerge. Newly emerged moths were sexed and only males used in the attractant trials. Moths were kept with food and water at ˜20° C. prior to use in the trial.

### EXPERIMENTAL PROCEDURE

Initial experiments were started within one or two days of the insect emergence and over the subsequent 4 days. The trial was carried out in the NRI wind tunnel measuring 150×30×30 cm. The test lure was attached to a wire at the upwind end of the tunnel and individual insects released at the down wind entrance. Each replicate was run over 3 minutes. The insect behaviour was observed. If the insect failed to reach the pheromone source within the 3 minutes it was counted as a non response. Insect contact time was recorded and these insect were then collected and caged separately with food and water and their survival monitored over a period of 22 hours. At 5 hour and 22 hour intervals the insects were assessed whether they were alive, moribund or dead.

Insecticide Preparations

Based on the results of the previous pheromone lure attraction and insecticide mortality studies 3 formulations were selected for this trial. From the pheromone work PP100 was selected as the pheromone lure component. This was used alone (with no insecticide) as a control treatment and in combination with the following two insecticide formulations, identified from Experiment 5, Type 2.2 and Type 2.5

Results and Discussion

The results of the experiment are presented in Table 3. The results show that the Type 2.2 insecticide formulation reduces the number of insects making contact with the device source and also reduces the amount of contact time. On the other hand Type 2.5 has virtually no effect on contact and seems to increase the period of contact time.

After contact with the source none of the pheromone only insects appear to show any ill effects. Some of the insects were moribund and a small number dead after 24 hours probably due to natural causes or having been handled in the experiment. For Type 2.2 there were a substantial number of moribund insects after 5 hours and a very few deaths. It is clear that some of the insects that appeared moribund after 5 hours either recovered or died by the 22 hour assessment. The number of deaths increase over the next 17 hours as some of the moribund insects died but never to the high levels observed in the previous experiment where the insects were placed on the insecticide surface.

Type 2.5 showed very high mortality after 5 hours with all but 5% of the remainder moribund. After 22 hours some of the moribund insects had either recovered or died. It should be noted that in the experiment the only insects which survived were those tested in the first 2 days of the experimental program. There after for the replicates carried out over the following four days mortality was 100% after 5 hours. The reason for this effect is unclear. It could be experimental error or it could reflect a change in the surface characteristics of the test device over time (the same devices were used for all replicates) which affect the insect pick of the insecticide.

TABLE 3
Results of the mortality trial.

| | Treatment | | | | | |
|---|---|---|---|---|---|---|
| | 100 PP | | | | | |
| | (pheromone only) | | 100PP/2.2 | | 100PP/2.5 | |
| | % contact with source | | | | | |
| | 63% | | 47% | | 61% | |
| | Average seconds contact +/− STD DEV | | | | | |
| | 24.9 +/− 30.4 | | 15.1 +/− 11.7 | | 38.2 +/− 42.5 | |
| Effect of | 5 | 22 | 5 | 22 | 5 | 22 |
| contact | hours | hours | hours | hours | hours | hours |
| Insects alive | 100% | 79% | 50% | 40% | 5% | 20% |
| Moribund | 0% | 16% | 43% | 33% | 26% | 10% |
| Dead | 0% | 5% | 7% | 27% | 69% | 70% |

### CONCLUSIONS

Whereas in the insecticide only experiments carried out previously the Type 2.2 formulation had shown a slight superiority to the Type 2.5, in the final experiment where the insect was allowed to behave naturally around the device the Type 2.5 formulation showed a clear superiority. This is more than likely due to the activating effect of the insecticide which reduced the insect's contact time with the insecticide and probably affected the way the insect interacted with the source. The micro-encapsulated Demand formulation in Type 2.5 allowed the insect to pick up a lethal dose before the active ingredient activated and repelled it.

The present invention will now be described by way of example only, with reference to the accompanying figures, wherein:

FIG. 1 is a graph representing the release rate of PE/HDPE and PE/PE materials for the system of the present invention, for the first experiment.

FIG. 2 is a graph representing the release rate of polypropylene and 2 layer material for the system of the present invention, for the second experiment.

FIG. 3 is a graph representing the release rate of codling pheromone from 1.6% loaded laminates.

FIG. 4 is a graph representing the release rate of codling pheromone from 10% loaded laminates.

FIG. 5 is a graph which identifies the actual release rate of trial formulations.

FIG. 6 represents the correlation between lure loading and daily release rate for 2 cm² polypropylene/polyester laminate device.

FIG. 7 is a graph which identifies the total morality of the different insecticide formulations for the two test runs in experiment 3.

FIG. 8 is a graph which identifies the rate of kill of the different insecticide formulations in experiment 4.

FIG. 9 is a graph which identifies the total morality of the different insecticide formulations for the two test runs, in experiment 4.

FIG. 10 is a graph which identifies the rate of kill of the different demand insecticide formulations.

FIG. 11 is a graph which shows the rate of kill of the different technical insecticide formulations of experiment 4.

FIG. 12 is a graph which identifies degradation of insecticides on samples exposed outside to the elements FIG. 13 graphically shows the residence time of codling moth in response to different sized systems.

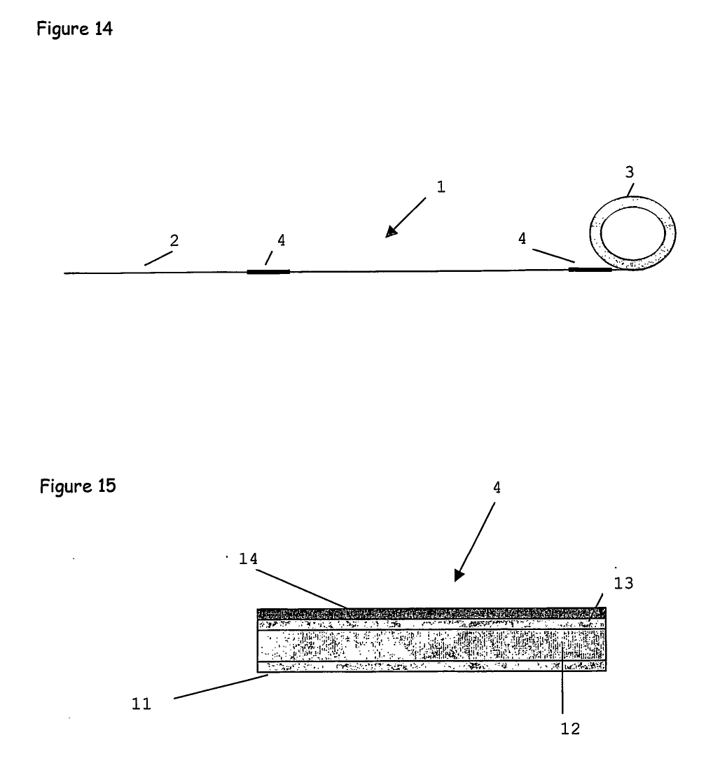

FIG. 14 represents a schematic drawing of a system according to the present invention;

FIG. 15 represents a schematic drawing of a target zone according to the present invention.

Referring to FIG. 14, there is provided an insect attracting system generally indicated by the numeral 1. The substrate 2 of adhesive tape which is rolled into a reel 3. The target zones 4 are spaced intermittently along the length of the substrate 2.

Referring to FIG. 15, where like numerals have been used to identify like parts given in FIG. 14, there is provided a target zone 4. The target zone 4 is in the form of a laminate type structure arranged on the substrate (not shown in FIG. 14) The laminate compromises an impermeable backing layer II, a pheromone reservoir layer 12, a semi-permeable layer 13, ad and insecticide coating 14.

1-28. (canceled)

29. A system for controlling insects, which system includes a substrate in the form of an elongate tape having thereon a plurality of target zones spaced apart at predetermined intervals along a first surface of the substrate, each target zone including an insect attractant and an insect control agent.

30. A system according to claim 29, wherein the substrate is wound into a reel or the like.

31. A system according to claim 29, wherein a surface of the substrate is coated with an adhesive material.

32. A system according to any preceding claim, wherein each target zone includes a laminate structure which includes the insect attractant and the insect control agent.

33. A system according to claim 32, wherein the laminate structure comprises an impermeable layer, the insect attractant layer, a semi-permeable layer and the insect control agent.

34. A system according to claim 32 or 33, wherein the impermeable layer is adjacent the substrate.

35. A system according to claim 32 or 33, wherein the substrate may be the impermeable layer of the laminate.

36. A system according to any of claims 33 to 35, wherein the impermeable layer and/or the semi-permeable layer are applied using a hot melt adhesive slot coater machine.

37. A system according to any of claims 33 to 36, wherein the impermeable layer includes a polyester such as a polyester based film.

38. A system according to any preceding claim, wherein the insect attractant includes a chemical attractant, a food based attractant, a synthetic attractant, a visual attractant or a host based attractant.

39. A system according to claim 38, wherein the chemical attractant is selected from the following list: Z-5-decenyl acetate, dodecanyl acetate, Z-7-dodecenyl acetate, E-7-dodecenyl acetate, Z-8-dodecenyl acetate, E-8-dodecenyl acetate, Z-9-dodecenyl acetate, E-9-dodecenylacetate, E-10-dodecenyl acetate, 11-dodecenyl acetate, Z-9,11-dodecadienyl acetate, E-9,11-dodecadienyl acetate, Z-11-tridecenyl acetate, E-1-tridecenyl acetate, tetradecenyl acetate, E-7-tetradecenyl acetate, Z-8-tetradecenyl acetate, E-8-tetradecenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tridecadienyl acetate, 4-methoxy-cinnamaldehyde, .beta.-ionone, estragole, eugenol, indole, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7,11-hexadecadienyl acetate, Z,E-3,13-octadecadienyl acetate, E,Z-3,13-octadecadienyl acetate, E,E-3,13-octadecadienyl acetate, ethanol, hexanol, heptanol, octanol, decanol, Z-6-nonenol, E-6-nonenol, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,10-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9,11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, E-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9,11-hexadecadienal, E,E-10,12-hexadecadienal, E,Z-10,12-hexadecadienal, Z,E-10,12-hexadecadienal, Z,Z-10,12-hexadecadienal, Z,Z-11,13-hexadecadienal, octadecanal, Z-11-octadecenal, E-13-octadecenal, Z-13-octadecenal, Z-5-decenyl-3-methyl-butanoate Disparlure: (+) cis-7,8-epoxy-2-methyloctadecane, Seudenol: 3-methyl-2-cyclohexen-1-ol, sulcatol: -methyl-5-hepten-2-ol, Ipsenol: 2-methyl-6-methylene-7-octen-4-ol, Ipsdienol: 2-methyl-6-methylene-2,7-octadien-4-ol, Grandlure I: cis-2-isopropenyl-1-methyl-cyclobutanethanol, Grandlure II: Z-3,3-dimethyl-1-cyclohexanethanol, Grandlure III: Z-3,3-dimethyl-1-cyclohexaneacetaldehyde, Grandlure IV: E-3,3-dimethyl-1-cyclohexaneacetaldehyde, cis-2-verbenol: cis-4,6,6-trimethylbicyclo>3,1,1!hept-3-en-2-ol cucurbitacin, 2-methyl-3-buten-2-ol, 4-methyl-3-heptanol, cucurbitacin, 2-methyl-3-buten-2-ol, 4-methyl-3-heptanol, .alpha.-pinene: 2,6,6-trimethylbicyclo>3,1,1!hept-2-ene, .alpha.-caryophyllene: 4,11,11-trimethyl-8-methylenebicyclo>7,2,0!undecane, Z-9-tricosene, .alpha.-multistriatin 2(2-endo, 4-endo)-5-ethyl-2,4-dimethyl-6,8-dioxabicyclo>3,2,1!octane, methyleugenol: 1,2-dimethoxy-4-(2-propenyl)phenol, Lineatin: 3,3,7-trimethyl-2,9-dioxatricyclo>3,3,1,0!nonane, Chalcogran: 2-ethyl-1,6-dioxaspiro>4,4!nonane, Frontalin: 1,5-Dimethyl-6,8-dioxabicyclo>3,2,1!octane, endo-Brevicomin: endo-7-ethyl-5-methyl-6,8-dioxabicyclo>3,2,1!octan, exo-brevicomin: exo-7-ethyl-5-methyl-6,8-dioxabicyclo>3,2,1!octane, (Z)-5-(1-decenyl)dihydro-2-(3H)-furanone, Farnesol 3,7-11-trimethyl-2,6,10-dodecatrien-1-ol, Nerolidol 3,7-,11-trimethyl-1,6,10-dodecatrien-3-ol, 3-methyl, 6-(1-methyl ethenyl)-9-decen-1-ol acetate, (Z)-3-methyl-6-(1-methylethenyl)-3,9-decadien-1-ol acetate, (E)-3,9-methyl-6-(1-methylethenyl)-5,8-decadien-1-ol-acetate, 3-methylene-7-methyl-octen-1-ol propionate, (Z)-3,7-dimethyl-2,7-octadien-1-ol propionate, (Z)-3,9-dimethyl-6-(1-methylethenyl)-3,9-decadien-1-ol propionate.

40. A system according to any preceding claim, wherein the attractant is in the form of a reservoir layer on the substrate.

41. A system according to claim 40, wherein the attractant is mixed with a carrier material so as to form the reservoir layer.

42. A system according to claim 41, wherein the reservoir is a solid material at normal operating temperatures.

43. A system according to claim 41 or 42, wherein the carrier material is a hot melt or pressure sensitive adhesive polymer, or a mixture of two or more such polymers.

44. A system according to claim 43, wherein the carrier includes Ethylene vinyl acetates (which is preferred), Hot melt adhesive mixes, Poly vinyl acetate (PVA) Poly vinyl chlorides (PVCs) and crossed linked acrylates.

45. A system according to claim 43, wherein the carrier material is a glue based mixture.

46. A system according to claims 40 to 43, wherein the insect attractant is dispersed in the polymer mixture so as to form the attractant reservoir.

47. A system according to claims 40 to 46, wherein the reservoir further includes a colour dye marker to visually confirm the distribution of the insect attractant.

48. A system according to claims 40 to 47, wherein the attractant is present in the reservoir in an amount 0.5 to 50% by weight of the reservoir, preferably 1 to 25% by weight.

49. A system according to claims 33 to 48, wherein the impermeable layer includes a vapour proof substrate, such as a polymer based film.

50. A system according to claims 33 to 49, wherein the semi-permeable layer permits controlled release of the insect control agent from the system.

51. A system according to any preceding claim, wherein the insect control agent is an insecticide.

52. A system according to any preceding claim, wherein the substrate acts as a control agent to provide a mass trapping type system.

53. A system according to claim 52, wherein an adhesive is attached to a surface of the substrate, the adhesive being arranged to trap the insect should it land on the substrate.

54. A system according to any preceding claim, wherein the insect to be controlled is the codling moth Laspeyresia pomonella) and the control agent is Lambda Cyhalothin.

55. A method of controlling insects in a defined area which method includes providing one or more systems for controlling insects according to any of claims 29 to 54, and positioning the systems throughout the defined area.
